(19) United States
(12) Patent Application Publication
(10) Pub. No.: US 2005/0108119 A1
(43) Pub. Date: May 19, 2005

(54) Portal for allowing access to application programs via a computer network

(76) Inventors: Ashley Thomas Beighton, Burford (GB); Colin Stuart Payne, Towcester (GB)

Correspondence Address: STOEL RIVES LLP, 900 SW FIFTH AVENUE, SUITE 2600, PORTLAND, OR, 97204, US

(21) Appl. No.: 10/713,536

(22) Filed: Nov. 14, 2003

(51) Int. Cl. G06F 15/16

(52) U.S. Cl. 705/34; 709/217

(57) ABSTRACT

A network-based portal comprises an access module allowing one or more users to access any one or more of a plurality of applications; and an invoicing module operable to maintain a record of usage that a user has made of at least one of the applications and generate an invoice amount based at least in part upon the recorded usage.

### TECHNICAL FIELD

This application relates to a portal, and in particular concerns a network-, Internet- or web-based portal that allows a number of users to access any of a plurality of software applications.

### BACKGROUND OF THE INVENTION

Software tools and applications are typically expensive, due to the large amounts of time and energy that are required to develop them, and are generally tailored to meet the requirements of the largest users or companies, since these entities are most likely to be able to afford to use such applications.

Software applications may be purchased on a computer-readable medium, such as a CD-ROM, which can be loaded on to one or more computers by the customer and are then ready for use.

An alternative method of purchasing software applications is to buy an Internet-based service, in which the customer is allowed access to a software application, through the Internet, and pays a flat time-related, for instance yearly or monthly, fee for doing so.

Such a system is not, however, convenient for smaller or more infrequent users, who may only wish to use the software applications occasionally, or may wish to access a number of different software applications at different times.

### SUMMARY OF THE INVENTION

Accordingly, one embodiment provides a network-based portal comprising: an access module allowing one or more users to access any one or more of a plurality of applications; and an invoicing module operable to maintain a record of usage that a user has made of at least one of the applications and generate an invoice amount based at least in part upon the recorded usage.

Advantageously, the invoicing module may be operable to maintain a record of at least one usage from the group of usages comprising: a quantity of page impressions made during use of the at least one application by the user; a quantity of SMS messages sent during use of the at least one application by the user; a quantity of projects accessed during use of the at least one application by the user; a volume of data stored during use of the at least one application by the user; and a length of time for which the user has accessed the at least one application.

Preferably, the access module may be operable to allow the one or more users to access respective ones of the plurality of applications simultaneously.

The access module may also be configured so that if a user has accessed one of the plurality of applications and has been inactive for a predetermined period of time, the access module will terminate the access of that user to the application. The predetermined period may be set individually for each user or group of users.

Preferably, the portal may further comprise a registration module to register new users of the portal, thereby creating an account for each user or for a group of users. The registration module may be configured to prevent a user from accessing any of the applications unless the user has previously obtained an account through the registration module. The registration module may allow a user to be registered as a group administrator, and allow further users to be registered as part of the group. A group administrator can then select applications that each member of the group may access via the access module.

Conveniently, the portal may further comprise a payment module that is operable to allow each user or group of users to select one of a plurality of usage tariffs which will be used to calculate invoice amounts for the user. The payment module may also be operable to allow each user or group of users to select one of a plurality of payment methods. For example, each user or group of users may select a first payment method to pay charges relating to initial costs and a second payment method to pay charges relating to recurring costs.

In another embodiment, a computer-readable medium may be encoded with computer-readable instructions for causing user equipment programmed thereby to perform a method of invoicing users for use of applications, the method comprising: allowing one or more users to access any one of a plurality of applications; maintaining a record of usage that a user has made of at least one of the applications; and generating an invoice amount for the user based at least in part upon the recorded usage.

A further aspect may provide a method of invoicing users for use of applications, the method comprising the steps of: allowing one or more users to access any one of a plurality of applications; maintaining a record of usage that a user has made of at least one of the applications; and generating an invoice amount based at least in part upon the recorded usage.

Conveniently, the step of maintaining a record of usage may comprise the step of maintaining a record of at least one usage from the group of usages comprising: a quantity of page impressions made during use of the at least one application by the user; a quantity of SMS messages sent during use of the at least one application by the user; a quantity of projects accessed during use of the at least one application by the user; a volume of data stored during use of the at least one application by the user; and a length of time for which the user has accessed the at least one application.

Advantageously, the method may further comprise the step of allowing each user or group of users to select one of a plurality of usage tariffs which will be used to calculate invoice amounts for the user. The method further may comprise the step of allowing each user or group of users to select one of a plurality of payment methods. Each user or group of users may also select a first payment method to pay charges relating to initial costs and a second payment method to pay charges relating to recurring costs.

Advantageously, the method may be implemented on a network-based portal.

In yet another embodiment, a computer-readable medium may be encoded with computer-readable instructions for causing user equipment programmed thereby to perform the methods described herein.

### BRIEF DESCRIPTION OF THE DRAWING

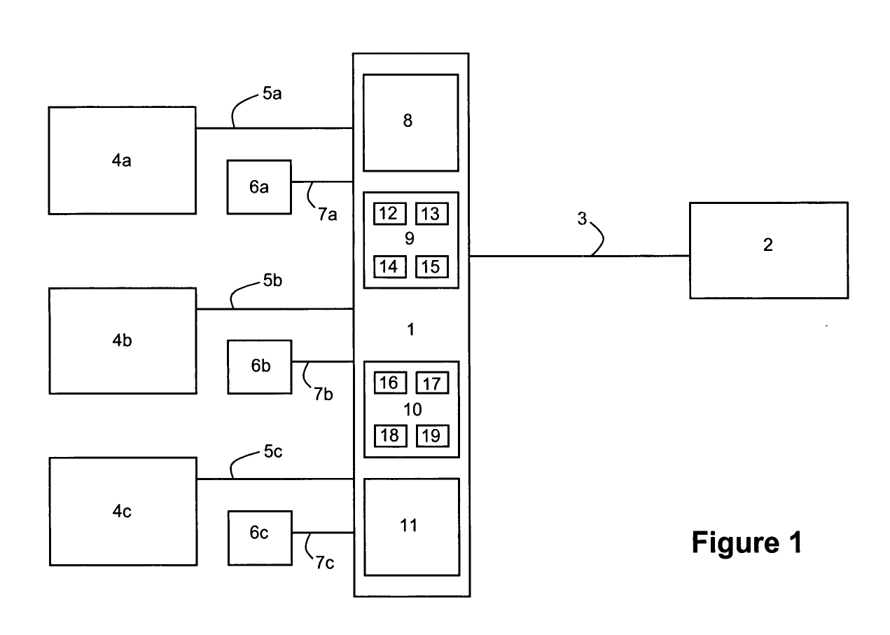

In order that the present invention may be more readily understood, embodiments thereof will now be described, by way of example, with reference to the accompanying FIG. 1, which shows a schematic representation of a portal in accordance with a preferred embodiment.

### DETAILED DESCRIPTION OF PREFERRED EMBODIMENTS

Referring to the FIG. 1, a portal 1 in accordance with a preferred embodiment is maintained on a server or network, which will be administered by a provider of the portal or by a supplier thereto. A user may access the portal 1 through his or her own PC or network 2, via a communication line 3, which may comprise the Internet, another computer network, or data network.

The portal 1 is connected to a number of Application servers 4a, 4b, 4c via respective communication lines 5a, 5b, 5c, any or all of which may comprise the Internet or any other data transmission network. The portal is also connected to a number of database servers 6a, 6b, 6c, each of which is associated with one of the application servers 4a, 4b, 4c, by respective communication lines 7a, 7b, 7c. In the depicted embodiment, the database servers 6a, 6b, 6c are connected directly to the portal 1, but the database servers 6a, 6b, 6c may be connected thereto via the second communication lines 5a, 5b, 5c or via the application servers 4a, 4b, 4c or any other suitable route.

The portal 1 comprises four main modules: a home page module 8, which may also be known as an access module, an e-commerce module 9, an administration module 10 and a help module 11. Within the e-commerce module 9, there are preferably four major components: a registration component 12, a selection component 13, an invoicing component 14 and a payment component 15. Within the administration module 10, there are also preferably four major components: a project registration component 16, an account management component 17, a user settings component 18 and a reward points component 19. Each of these modules 8, 9, 10, 11 and components 12, 13, 14, 15, 16, 17, 18, 19 will be described below in greater detail.

In use of the portal 1, a user accesses the portal 1 through the first communication line 3. If the user is a new user, the user is preferably directed to the registration component 12 of the portal e-commerce module 9. The registration component 12 prompts the new user to enter information such as the user's name, company, address, post/zip code and the like. The registration component 12 then uses this data to generate an account for the user, and provides the user with a unique user name and password to access this account.

At this stage the new user may be able to register him or herself as a group administrator. In this way, a group can be created, and further new users can be added as members of this group.

The registration component 12 then directs the new user to the selection component 13 of the e-commerce module 9, which prompts the new user to indicate which, of a plurality of available software applications, the user wishes to have access to. This selection is not final, and may be added to, deducted from or altered at a later date. The selected applications are stored as part of the account details of the new user.

In advantageous embodiments, a group administrator may be able to exercise a certain degree of control over the options available to new users that are registered as members of the group, as discussed in greater-detail below.

If the user is not a new user, or once the new user has been provided with a user name and password, the user is prompted by the portal 1 to log on by entering his or her unique user name or password. If the user is successful in logging onto the portal 1, then the user will gain access to a home page, provided by the home page module 8.

The home page module 8 is only available to registered users, and allows these users to access selected applications without further login details being required. The home page module 8 also allows users to access the e-commerce module 9, the administration module 10 or the help module 11. Each of these will be discussed in greater detail below.

As described above, the portal 1 has connections 5a, 5b, 5c to a plurality of application servers 4a, 4b, 4c, each of which supports one or more software applications. If the user has appropriate authorization, the user may access any one or more of the software applications through the home page, and the application(s) in question will then appear on the user's screen and the user will be able to use the application(s) in the normal manner. Examples of software applications that may be offered through a portal include accounting, procurement, audit and collaboration tools.

In preferred embodiments, users are able to select applications within a frame, thereby enabling single-click navigation between the applications. In addition, the home page module 8 may allow users to set a default application to view upon launching the home page.

Use of many types of software applications will generate data, which the user may wish to store and gain access to at a later date. In preferred embodiments, this data is stored on the database server 6a, 6b, 6c which is associated with the application server 4a, 4b, 4c on which the software application in question is maintained. The data is preferably maintained on one of the database servers 6a, 6b, 6c, rather than locally at the user's own PC or network 2, so that the data may be accessed when the user uses the software application in the future, no matter where the user is situated.

Once the user has finished using the software application, the user may select an alternative application to use, or may log out.

The invoicing component 14 of the e-commerce module 9 maintains a record of the amount of usage that each user makes of the software applications. For instance, the invoicing component may maintain a record of the number of page impressions made, the number of SMS messages sent, the number of projects accessed, the volume of data stored by a user during use of an application, the length of time that a user spends accessing each application, or any combination of these. This information can then be used to generate an invoice amount for each user or group of users, which is based upon the exact amount of usage that the user (or group of users) has made of each application. For instance, the invoice may comprise nominal flat fees for access to each application, a usage tariff fee dependent upon the usage tariff chosen and extra-over usage fees dependent upon the number of page impressions made, SMS messages sent, projects accessed and volume of data stored in relation to each application.

It will be appreciated that this system of billing is more appropriate for a small user who uses software applications only sporadically, or an infrequent user who wishes to gain access to many different software applications, and is likely to be more attractive to such users than a flat fee alone for monthly or yearly access to an application.

From the home page, the user may access the selection component 13 of the e-commerce module 9, which allows the user to view a listing of the applications to which the user currently has access. From this menu, the user may add or remove applications from the listing as desired. If the user is a group administrator, then the menu allows the user to access the listing to add or remove applications to which members of the group have access. Each member of the group may be granted access to a different set of applications. The menu may also allow the user or group administrator to access the payment component 15 of the e-commerce module 9, and select a payment method by which to pay for access to the applications. In preferred embodiments, the payment method selection may distinguish between initial and recurring costs. For example, a user or group administrator may chose to pay initial costs using a credit card, and recurring costs via a direct debit mandate (automatic payment). The payment component 15 of the e-commerce module 9 may also allow users to select from one of a plurality of usage tariffs.

Through the home page, a user may also access the administration module 10, and the various components thereof.

The project registration component 16 of the administration module 10 allows users to create new projects to invite new users to existing projects, and to register for access to existing projects. When a user creates a new project, the project registration component 15 gathers from the user all of the necessary information, such as the project name, address and so on. The project registration component 15 then generates a unique project identification number for the project.

The project is preferably configured so that the user creating the project is automatically designated as a project administrator, responsible for inviting new users to the project. However, the user or group administrator may also be allowed to select and designate one or more other users as project administrators. To invite a new user to the project, the project administrator enters the invited user's e-mail address or mobile telephone number into an electronic form, and the project registration component 15 then responds by automatically e-mailing the invited user, or sending an SMS message to the invited user, containing the unique project identification number for the project. Users other than the project administrator are preferably restricted from registering with an existing project until they have the appropriate project identification number. In other words, they will only be able to register once they have received an e-mail or SMS message from the project administrator inviting them to join the project.

The account management component 17 of the administration module 10 allows users to view and edit registration, selection, billing or payment details, to view initial or ongoing bills, to view and edit project registration, and to view or edit a project user group. The first two of these functions are preferably not made available to users within a group, with the exception of the group administrator. Both group and individual users may, however, have the ability to view and edit their project registration details. In other words, they will be able to un-register from existing projects. Project administrators are preferably also able to un-register to thereby cause data relating to existing projects to be deleted from within the various applications. Further, project administrators may also have the option to transfer their role across to another user.

To perform a project transfer, a project administrator first enters the new project administrator's e-mail address or mobile telephone number into an electronic form, and the account management component 17 may then respond by e-mailing the user or sending an SMS message to the user containing an automatically generated project transfer number. Once received, the prospective new project administrator can enter the project transfer number into a form, thereby completing the transfer and accepting the role of project administrator.

Administration module 10 may also allow project administrators to view and edit project user groups. Using this function, project administrators can retain overall control over which users are registered to access their project(s), and may un-register users when desired.

The user settings component 18 of the administration module 10 allows users to set default software applications to view on their home page.

The reward points component 19 of the administration module 10 allows both individual and group users to view a summary of their reward points account, if an appropriate reward points scheme is in operation. The reward points component 19 also, where appropriate, incorporates links to pages containing information relating to rewards and the like. To redeem points, users will enter an appropriate reward code in a form, and the reward points component 19 responds by automatically validating that the user's account holds sufficient points before emailing a helpdesk with details of the redemption request. In preferred embodiments, group administrators have the ability to disable this function on behalf of their user group. However, it is preferably not possible to hide the reward points component 19 from view.

The help module 11 may also be accessed through the home page module 8, and the help module 11 provides help and support to users, both with regard to use of the various modules and components of the portal 1 and with regard to use of the applications which may be accessed through the portal 1.

It will be appreciated that the preferred embodiments allow users to be billed for access to software applications in a fair way, based upon their actual usage of the applications. The embodiments also provide a portal through which users may share information and tasks in the course of a project, irrespective of the locations of the various users.

In this application, the terms “module” and “component” may be considered as interchangeable terms, there being no distinction between the function of a module and a component. Furthermore, “comprises” means “includes or consists of”, and “comprising” means “including or consisting of”.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof. The scope of the present invention should, therefore, be determined only by the following claims.

1. A network-based portal comprising:
an access module allowing one or more users to access one or more of a plurality of applications; and
an invoicing module operable to maintain a record of usage that a user has made via the access module of at least one of the applications and to generate an invoice amount based at least in part upon the recorded usage.

2. A portal according to claim 1, wherein the record of usage includes a record of a quantity of page impressions made during use of the at least one application by the user.

3. A portal according to claim 1, wherein the record of usage includes a record of a quantity of SMS messages sent during use of the at least one application by the user.

4. A portal according to claim 1, wherein the record of usage includes a record of a quantity of projects accessed during use of the at least one application by the user.

5. A portal according to claim 1, wherein the record of usage includes a record of a volume of data stored during use of the at least one application by the user.

6. A portal according to claim 1, wherein the record of usage includes a record of a length of time for which the user has accessed the at least one application.

7. A portal according to claim 1, wherein the access module is operable to allow the one or more users to access respective ones of the plurality of applications simultaneously.

8. A portal according to claim 1 wherein, if a user has accessed one of the plurality of applications and has been inactive for a predetermined period of time, the access module will terminate the access of that user to the application.

9. A portal according to claim 8, wherein the predetermined period may be set individually for each user or group of users.

10. A portal according to claim 1, further comprising a registration module to register new users of the portal, thereby creating an account for each user or for a group of users.

11. A portal according to claim 10, wherein a user may not access any of the applications unless the user has obtained an account through the registration module.

12. A portal according to claim 10, wherein the registration module allows a user to be registered as a group administrator, and allows further users to be registered as part of the group.

13. A portal according to claim 12, wherein the access module allows a group administrator to determine which of the plurality of applications each member of the group may access.

14. A portal according to claim 1, further comprising a payment module that is operable to allow each user or group of users to select one of a plurality of usage tariffs which will be used to calculate invoice amounts for the user.

15. A portal according to claim 1, further comprising a payment module that is operable to allow each user or group of users to select one of a plurality of payment methods.

16. A portal according to claim 15, wherein each user or group of users may select a first payment method to pay charges relating to initial costs and a second payment method to pay charges relating to recurring costs.

17. A computer-readable medium having encoded therein computer-readable instructions for causing user equipment programmed thereby to perform a method of invoicing users for use of applications, the method comprising:
allowing one or more users to access one or more of a plurality of applications;
maintaining a record of usage that a user has made of at least one of the applications; and
generating an invoice amount based at least in part upon the recorded usage.

18. A computer-implemented method of invoicing users for use of applications, the method comprising the steps of:
allowing one or more users to access one or more of a plurality of applications;
maintaining a record of usage that a user has made of at least one of the applications; and
generating an invoice amount based at least in part upon the recorded usage.

19. A method according to claim 18, wherein the usage recorded includes a quantity of page impressions made during use of the at least one application by the user.

20. A method according to claim 18, wherein the usage recorded includes a quantity of SMS messages sent during use of the at least one application by the user.

21. A method according to claim 18, wherein the usage recorded includes a quantity of projects accessed during use of the at least one application by the user.

22. A method according to claim 18, wherein the usage recorded includes a volume of data stored during use of the at least one application by the user.

23. A method according to claim 18, wherein the usage recorded includes a length of time for which the user has accessed the at least one application.

24. A method according to claim 18; further comprising the step of allowing each user or group of users to select one of a plurality of usage tariffs which will be used to calculate invoice amounts for the user.

25. A method according to claim 18, further comprising the step of allowing each user or group of users to select one of a plurality of payment methods.

26. A method according to claim 25, further comprising the step of allowing each user or group of users to select a first payment method to pay charges relating to initial costs and a second payment method to pay charges relating to recurring costs.

27. A method according to claim 18, implemented on a network-based portal.

28. A computer-readable medium having encoded therein computer-readable instructions for causing user equipment programmed thereby to perform the method of claim 18.
